(19) United States
(12) Patent Application Publication
(10) Pub. No.: US 2024/0399435 A1
(43) Pub. Date: Dec. 5, 2024

(54) BENDING METHOD AND BENDING APPARATUS FOR BENDING ARRESTER TABS OF BATTERY CELLS, IN PARTICULAR POUCH CELLS

(71) Applicant: GROB-WERKE GmbH & Co. KG, MINDELHEIM (DE)

(72) Inventors: Christoph RIEDLER, THANNHAUSEN (DE); Patrick HIERL, ALTENSTEIG (DE)

(21) Appl. No.: 18/677,328

(22) Filed: May 29, 2024

(30) Foreign Application Priority Data
May 31, 2023 (DE) 102023114242.9
Aug. 3, 2023 (DE) 102023120641.9

(51) Int. Cl. B21D 5/16; H01M 50/516; H01M 50/557

(52) U.S. Cl. CPC B21D 5/16; H01M 50/516; H01M 50/557

(57) ABSTRACT

A bending method for bending the arrester tabs by providing a first battery cell having a first arrester tab and a second battery cell having a second arrester tab, and bending the first arrester tab and the second arrester tab differently. The bending comprises the steps of: providing a first and a second holding device for holding a first and a second end portion respectively of the arrester tab to be bent, the holding devices being relatively movable with a computer-controlled relative moving device; holding the first arrester tab with the holding device and controlling the relative movement device to bend the first arrester tab into a first bent shape; and holding the second arrester tab with the holding device and controlling the relative movement device differently from the previous step to bend the second arrester tab into a second bent shape different from the first bent shape.

### CROSS-REFERENCES TO RELATED APPLICATIONS

This application claims the benefit of German Patent Application Number 102023114242.9 filed on May 31, 2023, and German Patent Application Number 102023120641.9 filed on Aug. 3, 2023 the entire disclosures of which are incorporated herein by way of reference.

### FIELD OF THE INVENTION

The invention relates to a bending method to be carried out in the course of manufacturing a battery module or a battery pack from battery cells, such as pouch cells or solid-state battery cells, for bending arrester tabs of battery cells. The invention further relates to a manufacturing method for manufacturing a battery module or battery pack from battery cells, such as pouch cells or solid-state battery cells, by performing such a bending process. Further, the invention relates to a bending apparatus for bending arrester tabs of battery cells in the course of manufacturing a battery module or battery pack from battery cells, such as in particular pouch cells or solid-state battery cells, and to a use of such a bending apparatus. Finally, the invention relates to a control unit and a computer program for such a bending apparatus.

### BACKGROUND OF THE INVENTION

The invention is in the field of manufacturing batteries and their pre-products, in particular in the field of electromobility. In particular, the invention relates to methods and apparatus which are used in the manufacture of battery modules from battery cells, such as in particular pouch cells or solid-state battery cells.

In addition to the prismatic cell and the round cell, pouch cells are a frequently used cell type in the field of E-mobility. Pouch cells, also known as coffee bags, have several layers of cathodes and anodes stacked on top of each other and surrounded by a foil. A pouch cell always has two arrester tabs (positive and negative pole; these can also be bent differently).

To connect the individual pouch cells electrically, the arrester tabs of the individual pouch cells are contacted with each other. Employing this method, the cells can be used to form modules for a battery pack. There is a trend towards connecting pouch cells directly to form a battery pack instead of a battery module as an “intermediate product”. In addition to pouch cells, other battery cells, such as future solid-state battery cells, can also have arrester tabs that can be connected to each other in a similar way.

In order for the arrester tabs of several cells to make contact, they must be shaped accordingly. The apparatus known to date are based on the principle of die bending. In this process, a punch presses the arrester tab into a die to form the desired shape. Die bending enables the arrester tab to be formed quickly and accurately. However, this is offset by the fact that only one specific shape can be produced with one apparatus. The tool set (punch and die) must be replaced in order to produce a different shape of the arrester tab.

### SUMMARY OF THE INVENTION

It is an object of the invention to enable greater flexibility and in particular less effort in the process of bending arrester tabs of different battery cells to connect the battery cells to form a battery module or a battery pack in industrial mass production.

To achieve this object, the invention provides a bending method according to one or more embodiments. A manufacturing method for battery modules or battery packs using such a bending method, a bending apparatus which is suitable for carrying out the bending method, a use thereof for bending arrester tabs of different pouch cells, and an electronic control unit and a computer program for such a bending apparatus are also disclosed.

According to a first aspect, the invention provides a bending method to be carried out in the course of manufacturing a battery module or a battery pack from battery cells, such as in particular pouch cells or solid-state battery cells, for bending arrester tabs of battery cells, the method comprising:
a) providing a first battery cell with a first arrester tab and a second battery cell with a second arrester tab and
b) bending over the first arrester tab and the second arrester tab in such a way that the first and second arrester tabs are bent differently;
   wherein step b) comprises the steps of:
b1) providing a bending apparatus having first holding device for holding a first end portion of the arrester tab to be bent, a second holding device for holding a second end portion of the arrester tab to be bent, and a computer-controlled relative movement device for relatively moving the first and second holding devices in at least two moving directions,
b2) holding the first arrester tab with the first and second holding devices and controlling the relative movement device to bend the first arrester tab into a first bent
b3) holding the second arrester tab with the first and second holding devices and controlling the relative movement device differently from step b2) in order to bend the second arrester tab into a second bent shape different from the first bent shape.

Accordingly, an arrester tab of the first battery cell (e.g. first pouch cell) is referred to as the first arrester tab. This may be the positive pole arrester tab or/and the negative pole arrester tab of the first battery cell. In some embodiments, both first arrester tabs of the first battery cell are bent, possibly also differently. An arrester tab of the second battery cell (e.g., second pouch cell) is referred to as the second arrester tab. This can be the positive pole arrester tab or the negative pole arrester tab of the second battery cell. In some embodiments, both second arrester tabs of the second battery cell are bent, possibly also differently.

It is preferred that step b1) comprises:
providing the relative movement device with a longitudinal movement unit for the relative, preferably linear, movement of the first and the second holding device with at least one directional component in the longitudinal direction to the arrester tab to be bent.

It is preferred that step b1) comprises:
providing the relative movement device with a transverse movement unit for the relative, preferably linear, movement of the first and the second holding device with at least one directional component transversely to the arrester tab to be bent.

It is preferred that step b1) comprises:
providing the relative movement device with a rotary movement unit for the relative rotation of the first and the second holding device.

It is preferred that step b1) comprises:
providing the first holding device with a first clamping unit, which has a first hold-down device, with a second clamping unit, which has a second hold-down device, and with at least one presser arranged on at least one of the clamping units so as to be movable relative thereto,
and the first end portion is held by relative movement of the first and second hold-down devices towards one another and the arrester tab is brought into a defined position by the at least one presser.

It is preferred that step b1) comprises:
providing the second holding device with a parallel gripper which is movable by the relative movement device for bending the arrester tab.

It is preferred that step b) comprises:
b.i) closed-loop controlling, controlling and/or monitoring the forces at the relative movement device when performing step b2) and/or b3) in order to avoid damage to the arrester tab during bending and/or to detect incorrectly bent arrester tabs.

It is preferred that step b) comprises:
b.ii) controlling the relative movement device such that a recovery of the arrester tab due to an elastic material behavior is compensated.

It is preferred that step b) comprises:
b.iii) bending arrester tabs with different thicknesses and/or materials with the bending apparatus without changing tools.

It is preferred that step b) comprises:
b.iv) moving the entire bending apparatus to adjust to the respective position of the battery cell to be processed and/or to move the bending apparatus to a rest and/or maintenance position.

It is preferred that step b) comprises:
b.v) preferably moving the first battery cell laterally into the bending apparatus, clamping the first end portion of the first arrester tab with the first holding device, positioning the first arrester tab by means of a positioning element, clamping the second end portion of the first arrester tab with the second holding device, bending the first arrester tab by moving the second holding device in accordance with a first movement pattern, opening the first and second holding devices and clocked onward movement of the first battery cell.

It is preferred that step b) comprises:
b.vi) preferably moving the second battery cell laterally into the bending apparatus, clamping the first end portion of the second arrester tab with the first holding device, positioning the second arrester tab by means of a positioning element, clamping the second end portion of the second arrester tab with the second holding device, bending the second arrester tab by moving the second holding device in accordance with a second movement pattern, opening the first and second holding devices and clocked onward movement of the second battery cell.

According to a further aspect, the invention provides a manufacturing method for manufacturing a battery module or battery pack from battery cells, such as pouch cells or other battery cells with arrester tabs, the method comprising:
performing the bending process according to any one of the preceding embodiments; and
c) electrically contacting the first and second arrester tabs to form the battery module.

According to a further aspect, the invention provides a bending apparatus for bending arrester tabs of battery cells, such as pouch cells, in the course of manufacturing a battery module or battery pack from battery cells provided with arrester tabs, such as pouch cells, the apparatus comprising:
a first holding device for holding a first end portion of the arrester tab to be bent, a second holding device for holding a second end portion of the arrester tab to be bent, and a computer-controlled relative movement device for the relative movement of the first and second holding devices in at least two directions of movement, as well as an (electronic, in particular computer-implemented) control unit which is designed to control the relative movement device in accordance with a first movement pattern for bending a first arrester tab into a first bent shape and in accordance with a second movement pattern for bending a second arrester tab into a second bent shape.

It is preferred that the control unit is arranged to control the bending apparatus for carrying out the bending method according to any one of the preceding embodiments.

It is preferred that the relative movement device has a longitudinal movement unit for the relative, preferably linear, movement of the first and second holding devices with at least one directional component in the longitudinal direction to the arrester tab to be bent.

It is preferred that the relative movement device has a transverse movement unit for the relative, preferably linear, movement of the first and second holding devices with at least one directional component transverse to the arrester tab to be bent.

It is preferred that the relative movement device has a rotary movement unit for the relative rotation of the first and second holding devices.

It is preferred that the respective units of the relative movement device each have a linear axis which has a linear movement mechanism and a servo drive.

It is preferred that the holding devices and the relative movement device are arranged on a linearly movable base that is movable between a waiting or maintenance position and a bending position for performing the bending.

It is preferred that the first holding device has a first clamping unit with a first hold-down device, a second clamping unit with a second hold-down device and at least one presser arranged on at least one of the clamping units so as to be movable relative to the latter.

It is preferred that a bending unit is provided which has a gripper, which can be moved by means of the relative movement device, as a second holding device.

According to a further aspect, the invention provides a use of a bending apparatus according to any one of the preceding embodiments for different bending of arrester tabs of a plurality of battery cells (such as pouch cells) in order to connect them together when manufacturing a cell module or cell pack.

According to a further aspect, the invention provides an (electronic, in particular computer-implemented) control unit for a bending apparatus according to any one of the preceding embodiments, wherein the control unit is adapted to control the bending apparatus for carrying out the bending method according to any one of the above-mentioned embodiments in such a way that arrester tabs of battery cells which are to be assembled to form a cell module or cell pack are bent differently.

According to a further aspect thereof, the invention provides a computer program comprising instructions which cause a bending apparatus according to any one of the preceding embodiments to perform the bending method according to any one of the above embodiments.

For the production of battery modules from battery cells provided with arrester tabs, such as in particular pouch cells, various bending shapes of the arrester tab are necessary to date for the contacting. This means that a separate die bending apparatus is required for each bending shape. Due to the development towards larger modules, new battery cells such as pouch cells require a larger number of different bending molds for contacting. This leads to high costs due to the large number of bending apparatuses required, which on the one hand incur costs and on the other hand increase the space requirements of such a bending system. In addition, changing tools on a bending apparatus is time-consuming due to the subsequent need to readjust the apparatus. It is therefore desirable to provide a bending apparatus with greater flexibility with regard to different bending shapes.

Embodiments of the invention provide for arrester tab servo bending.

In order to make the bending apparatus more flexible for different bending shapes and thus avoid a tool change, a bending apparatus with several movable axes is provided in some embodiments. These axes enable both a linear and a rotational movement of the bending tool and thus offer a variety of different bending shapes that can be implemented.

In contrast to prior art, arrester tab servo bending makes it possible to produce different bending shapes with one bending apparatus without having to change tools.

In some embodiments, the linear axes used in this case also offer monitoring of the forces occurring during the shaping process. As a result, damage to the arrester tab can be avoided or damaged cells can be removed due to detection in the further process. The arrester tab servo bending can compensate for the recovery of the arrester tab due to elastic material behavior.

Compared to prior art, in some embodiments, the bending apparatus can flexibly compensate for recovery. As a result, a bending apparatus can be used to shape arrester tabs of different thicknesses and materials without having to change tools.

In some embodiments, furthermore, the entire bending apparatus is mounted on a further linear axis (e.g., telescopic extension), which makes it possible to adjust the bending apparatus to the exact position of the battery cell.

In some embodiments, the bending apparatus can also be moved out of the station into an easily accessible maintenance position via this additional axis.

### BRIEF DESCRIPTION OF THE DRAWINGS

Examples of embodiments are explained in more detail below with reference to the accompanying drawings.

FIG. 1 shows a schematic perspective view of several battery cells, here in the form of pouch cells, according to a first embodiment, which are to be combined to form a battery module or a battery pack;

FIG. 2 shows a first and a second pouch cell according to a second embodiment which are to be combined to form a battery module or a battery pack;

FIG. 3a shows a side view of an arrester tab of one of the pouch cells in an initial state (unbent);

FIG. 3b shows a side view of the arrester tab that has been bent into a V-shape;

FIG. 3c shows a side view of the arrester tab that has been bent into a Z-shape;

FIG. 4 shows a side view of a bending apparatus for different bending of arrester tabs of the pouch cells of FIG. 1 or 2;

FIG. 5 shows a side view of a clamping unit of the bending apparatus of FIG. 4 which is enlarged compared to FIG. 4;

FIG. 6 shows a side view of a bending unit of the bending apparatus of FIG. 4 which is enlarged compared to FIG. 4; and

FIG. 7 shows a top view of the bending unit of FIG. 6.

### DETAILED DESCRIPTION OF THE PREFERRED EMBODIMENTS

In the following, embodiments of a bending method and a bending apparatus 30 for bending arrester tabs 12.1a-12.4a, 12.1b-12.4b of pouch cells 14.1-14.4 in the course of manufacturing a battery module or a battery pack from pouch cells 14.1-14.4 are explained with reference to the attached drawing Figures. Although the bending method and the bending apparatus are described with reference to the preferred use of bending arrester tabs of pouch cells, they are also suitable for bending arrester tabs of other battery cell types. For example, solid-state battery cells can also be provided with comparable arrester tabs that are to be bent in the same way as the arrester tabs of the pouch cells in order to assemble the battery cells into modules or packs.

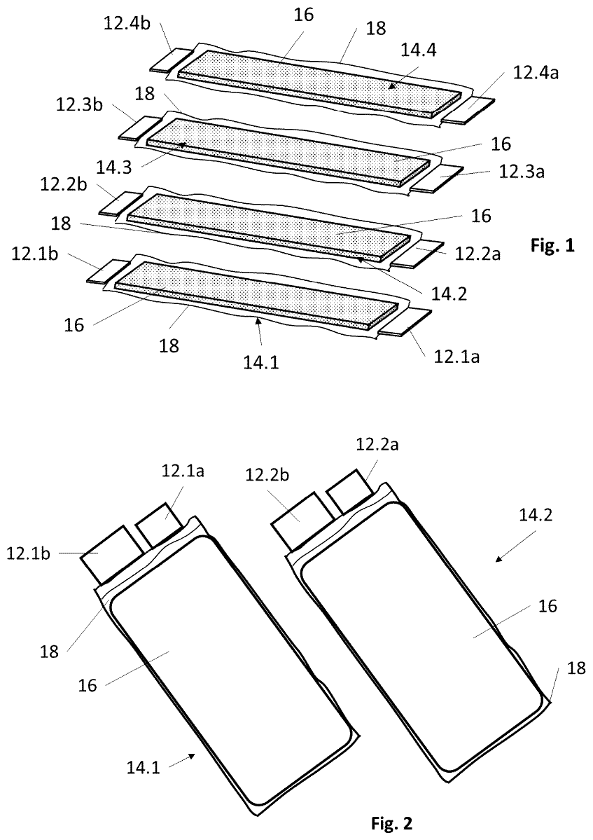

FIGS. 1 and 2 show different embodiments of pouch cells 14.1-14.4. Each of the pouch cells 14.1-14.4 has an electrode arrangement 16 consisting of stacked anodes and cathodes in a foil envelope 18 as well as a positive pole arrester tab 12.1a-12.4a and a negative pole arrester tab 12.1b-12.4b.

In FIG. 1, for example, a first to fourth pouch cell 14.1-14.4 are shown, in which the positive pole arrester tabs 12.1a-12.4a and the negative pole arrester tabs 12.1b-12.4b protrude from opposite sides of the foil envelope 18. The first pouch cell 14.1 has a first arrester tab 12.1a for the positive pole and a first arrester tab 12.1b for the negative pole. The second pouch cell 14.2 has a second arrester tab 12.2a for the positive pole and a second arrester tab 12.2b for the negative pole. The third pouch cell 14.3 has a third arrester tab 12.3a for the positive pole and a third arrester tab 12.3b for the negative pole. And the fourth pouch cell 14.4 has a fourth arrester tab 12.4a for the positive pole and a fourth arrester tab 12.4b for the negative pole. To form the battery module or battery pack, the first to fourth arrester tabs 12.1a-12.4a for the positive pole are connected together, and the first to fourth arrester tabs 12.1b-12.4b for the negative pole are also connected together.

In FIG. 2, only the first and second pouch cells 14.1, 14.2 are shown in a different design. As can be seen from this, the arrester tabs 12.1a, 12.1b, 12.2a, 12.2b can be arranged differently on the pouch cell 14.1, 14.2, e.g., they can protrude on the same side from the foil envelope 18.

The bending methods explained in more detail below are each applicable to the different embodiments of pouch cells 14.1-14.4.

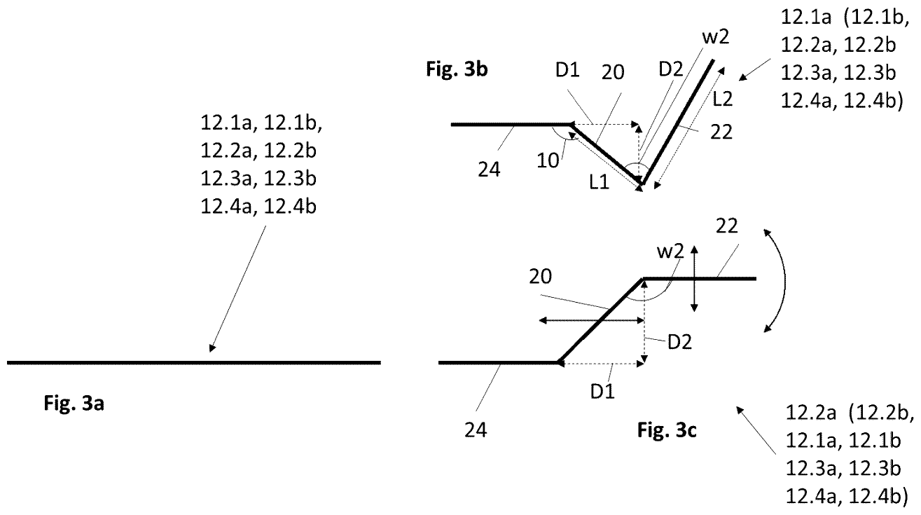

Reference is now made to FIGS. 3a to 3c. The arrester tabs 12.1a-12.4a, 12.1b-12.4b should be bent appropriately depending on the position that the respective pouch cell 14.1-14.4 is to occupy in the battery module or battery pack. For this purpose, the arrester tabs 12.1a-12.4a, 12.1b-12.4b of pouch cells 14.1-14.4, which are to be arranged at different positions in the battery pack or the battery module, should also be bent differently. For example, the first positive pole arrester tab 12.1a on the first pouch cell 14.1 is bent into a different shape than the second positive pole arrester tab 12.2a on the second pouch cell 14.2. It may also be desirable to bend the positive pole arrester tab 12.1a-12.4a and the negative pole arrester tab 12.1b-12.4b of the same pouch cell 14.1-14.2 differently.

FIG. 3a shows a side view of the initial state of the initially unbent arrester tabs 12.1a-12.4a, 12.1b-12.4b.

For example, depending on the design of the battery module or the battery pack, a V-shape as shown in FIG. 3b is desired for at least some of the arrester tabs 12.1a-12.4a, 12.1b-12.4b, with the respective arrester tab 12.1a-12.4a, 12.1b-12.4b being bent into two legs 20, 22 that are angled towards each other. The length L1 and L2 of the respective legs 20, 22, the distance D1, D2 of the bending edges in the longitudinal direction to the tab (X direction), the angle w1 between the first leg 20 and a base 24 of the arrester tab 12.1a.12.4a, 12.1b-12.4b as well as the angle w2 between the legs 20, 22 can be different for the arrester tabs 12.1a-12.4a, 12.1b-12.4b of the different pouch cells 14.1-14.4.

In particular, the V-shape can be defined by the dimensions D1, D2 and w2, where D1 is the distance between bending edges of the shape along the base (in the X-direction), D2 is the distance of the bending edge formed between the legs from the base in the direction transverse to the extension of the base (Y-direction) and w2 is the angle at the bending edge between the legs.

In other embodiments, the respective arrester tab 12.1a-12.4a, 12-1b-12.4b of at least some of the pouch cells 14.1-14.4 may be bent into a Z-shape as shown in FIG. 3c. For example, in the Z-shape, an offset is provided, wherein a first leg 20 extends obliquely from a base 24 and extends with a dimension D1 in the direction of the extension of the base 24 away (e.g. X-direction) from the base 24 and a second leg 22 with a dimension D2 is offset from the base 24 in a direction transverse to the extension of the base 24 (e.g. Y-direction) and is inclined at an angle w2 to the first leg 20. Here too, the values of the dimensions D1, D2, the respective lengths of the legs 20, 22 and the angles w1, w2 can be different for the different arrester tabs 12.1a-12.4a, 12.1b-12.4b.

The Z-shape can also be defined in particular by the dimensions D1, D2 and w2, where D1 is the distance between bending edges of the shape along the base (in the X-direction), D2 is the distance of the bending edge formed between the legs from the base in the direction transverse to the extension of the base (Y-direction) and w2 is the angle at the bending edge between the legs.

Also, some of the arrester tabs 12.1a-12.4a may be bent in a V-shape and others may be bent in a Z-shape.

Whereas in prior art a separate bending mold had to be provided for each of these individual different shapes for die bending the respective arrester tab 12.1a-12.4a, 12.1b-12.4b, bending of the arrester tabs 12.1a-12.4a, 12.1b-12.4b according to the bending method shown here takes place between a first and a second holding device, which holding devices are moved relative to one another in a numerically controlled manner in order to obtain the different bending shapes. In particular, the variables D1, D2 and w2 of the respective shape can serve as input variables for this purpose.

A bending method is thus proposed for bending arrester tabs of battery cells, such as pouch cells in particular, which is to be carried out in the course of manufacturing a battery module or a battery pack from battery cells, such as pouch cells, the method comprising the following steps:
a) providing a first battery cell (in particular a first pouch cell 14.1) with a first arrester tab 12.1a, 12.1b and a second battery cell (in particular a second pouch cell 14.2) with a second arrester tab 12.2a, 12.2b and
b) bending over the first arrester tab 12.1a, 12.1b and the second arrester tab 12.2a, 12.2b in such a way that the first arrester tab 12.1a, 12.1b and the second arrester tab 12.2a, 12.2b are bent differently.

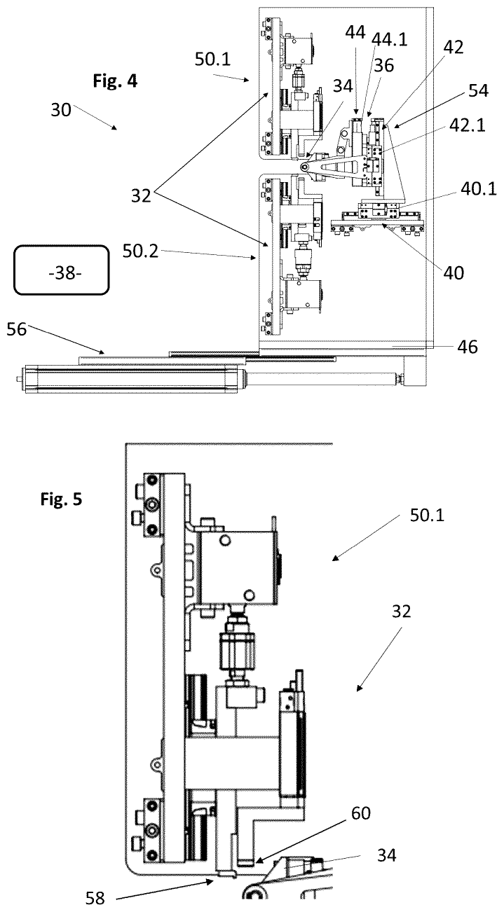

To perform the different bending operations according to step b), a bending apparatus 30 is provided, as explained in more detail below with reference to the illustrations in FIGS. 4 to 7.

The bending apparatus 30 comprises a first holding device 32 for holding a first end portion—for example the base 24—of the arrester tab 12.1a-12.4a, 12.1b-12.4b to be bent, a second holding device 34 for holding a second end portion—for example the free second leg 22—of the arrester tab 12.1a-12.4a, 12.1b-12.4b to be bent and a computer-controlled relative movement device 36 for the relative movement of the first and second holding devices 32, 34 in at least two directions of movement.

To bend the first arrester tab 12.1a, 12.1b, it is held by the first and second holding device 32, 34, and the relative movement device 36 is controlled according to a predefined first movement pattern to bend the first arrester tab 12.1a, 12.1b into a first bent shape.

Similarly, for example after completion of the bending operations for the first pouch cell 14.1, the second arrester tab 12.2a, 12.2b of the second pouch cell 14.2 is held with the first and second holding device 32, 34, and the relative movement device 36 is controlled differently from the bending of the first arrester tab 12.1a, 12.1b—in particular according to a second predefined movement pattern—in order to bend the second arrester tab 12.2a, 12.2b into a second bent shape different from the first bent shape.

Such bending is then carried out—again with different control of the relative movement device 36—for the third, fourth and each further arrester tab 12.3a, 12.3b, 12.4a, 12.4b.

Examples of the different shapes are shown in FIGS. 3b and 3c, wherein the dimensions D1, D2, w2 may be different for different shapes.

The bending apparatus 30 has a control unit 38 which is designed to control the relative movement device 36 in accordance with the first movement pattern for bending the first arrester tab 12.1a, 12.1b into the first bent shape and in accordance with the second movement pattern for bending the second arrester tab 12.2a, 12.2b into the second bent shape and for controlling in accordance with the further movement patterns for bending the further arrester tabs into the respectively desired shape.

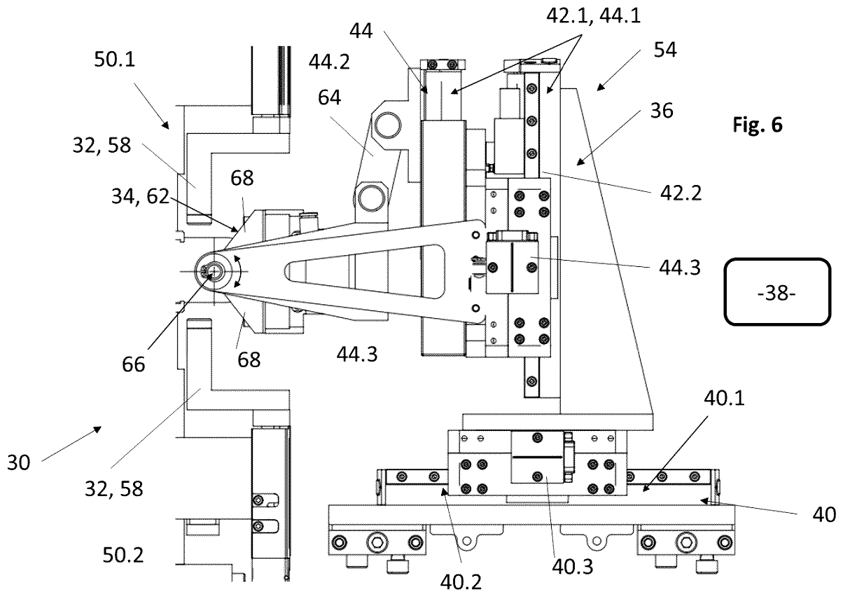

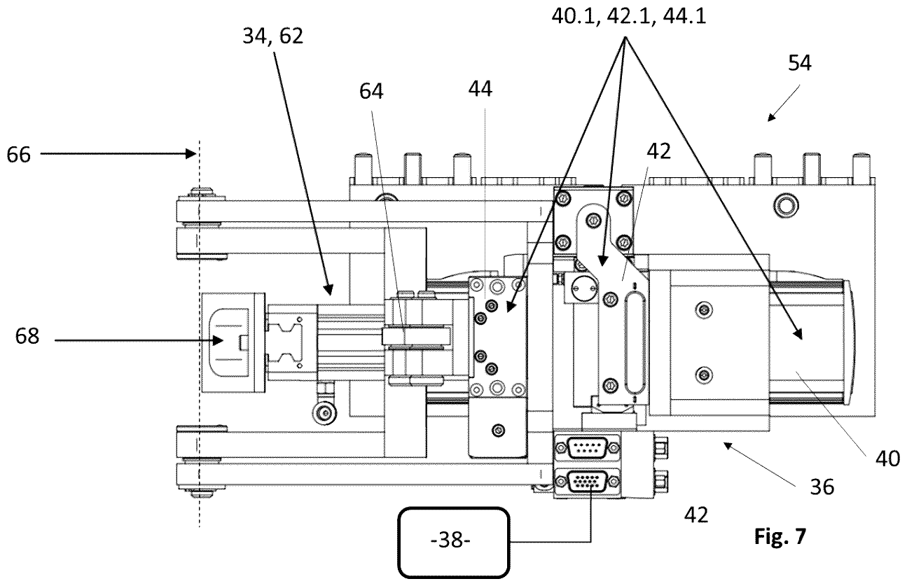

According to FIGS. 6 and 7, the relative movement device 36 has a longitudinal movement unit 40 for the relative, in particular linear, movement of the first and second holding devices 32, 34 with at least one directional component in the longitudinal direction to the arrester tab 12.1a.12.4a, 12.1b-12.4b to be bent (in particular in the X-direction), a transverse movement unit 42 for the relative, in particular linear, movement of the first and the second holding device 32, 34 with at least one directional component transverse to the arrester tab 12.1a-12.4a, 12.1b, 12.4b to be bent (in particular in the Y-direction), and a rotary movement unit 44 for the relative rotation of the first and the second holding device 32, 34.

In the embodiment shown, the respective units 40, 42, 44 of the relative movement device 36 each have a linear axis 40.1, 42.1, 44.1 having a linear movement mechanism 40.2, 42.2, 44.2 and a servo drive 40.3, 42.3, 44.3 controlled by the control unit 38.

According to FIG. 4, the holding devices 32, 34 and the relative movement device 36 are arranged on a linearly movable base 46 that can be moved between a waiting or maintenance position shown in FIG. 4 and a bending position for carrying out the bending operation.

The bending apparatus 30 is, for example, a bending station provided in a production plant for battery modules or battery packs for preparing the battery cells provided with arrester tabs, such as pouch cells in particular, for integration into the battery modules or battery packs.

According to FIG. 4, the bending apparatus 30, which is designed in particular as a servo bending apparatus, has a first clamping unit 50.1, a second clamping unit 50.2, a bending unit 54 and a telescopic extension 56.

By means of the telescopic extension 56, the base 46 can be moved between the waiting or maintenance position and the bending position.

In the embodiment shown, the first holding device 32 is formed by the first and second clamping units 50.1, 50.2 which are arranged as mirror images of one another and have a similar structure. The structure of the clamping units 50.1, 50.2 is described below using the example of the first clamping unit 50.1 shown in FIG. 5.

The respective clamping unit 50.1, 50.2 each has a hold-down device 58 and a presser 60. By moving the clamping units 50.1, 50.2 towards each other, the arrester tab 12.1a-12.4a, 12.1b-12.4b to be bent is clamped for the forming process (at the base 24). The presser 60 is movable relative to the hold-down device 58. Being controlled by the control unit 38, the presser 60 brings the arrester tab 12.1a-12.4a, 12.1b-12.4b to be bent into a defined position so that the bending unit 54 can grip it. The presser 60 thus forms a positioning element for positioning the arrester tab.

According to FIGS. 6 and 7, the bending unit 54 has the relative movement device 36 and the second holding device 34. In the embodiment shown, the bending unit has the first to third linear axes 40.1, 42.1, 44.1 and a gripper, for example designed as a parallel gripper 62, as the second holding device 34.

The parallel gripper 62 is connected to the linear axes 40.1, 42.1, 44.1 and thus executes the bending movement. The first and second linear axes 40.1, 42.1 lead to a linear movement of the parallel gripper 62 in one plane (e.g. X-Y plane).

Thus, the bends of FIGS. 3b and 3c can be created according to the dimensions D1 and D2.

The third linear axis 44.1 transmits its movement to the parallel gripper 62 via a coupling rod 64 and thus enables a rotational movement of the parallel gripper 62 about an axis of rotation 66 perpendicular to the plane of movement of the first and second linear axes 40.1, 42.1. The axis of rotation 66 of the rotational movement is defined by the mounting of the parallel gripper in such a way that it is located at the front edge of gripper jaws 68 of the parallel gripper 62.

This allows the bending between the legs 22.1, 22.2 to be performed by the angle w2.

The sequence of the bending process, which is automatically controlled by the control unit 38, is as follows:

For the bending process, a battery cell—in this case a pouch cell 14.1-14.4—is first moved laterally into the bending apparatus 30. The cell 14.1-14.4 is then clamped with the hold-down device 58, and the presser 60 brings the arrester tab 12.1a-12.4a, 12.1b, 12.4b into position. The bending unit 54 now moves onto the arrester tab 12.1a-12.4a, 12.1b, 12.4b so that the arrester tab threads between the gripper jaws 68 of the parallel gripper 62.

The pressers 60 then move back and the bending unit 54 moves forward to the clamping position. The parallel gripper 62 clamps the arrester tab 12.1a-12.4a, 12.1b, 12.4b, and the bending shape is created with the linear axes 40.1, 42.1, 44.1.

After shaping, the parallel gripper 62 and hold-down device 58 open to enable a clocked onward movement of the pouch cell 14.1-14.4.

After bending the arrester tabs 12.1a-12.4a, 12.1b-12.4b, the battery cells—in this case pouch cells 14.1-14.4—are inserted into a battery module or a battery pack and the arrester tabs 12.1a-12.4a and 12.1b-12.4b are contacted with one another, for instance welded together, in the correspondingly desired connection.

The control unit 38 is an electronic control unit which can be designed in software and/or hardware. In particular, the control unit 38 has a processor and a memory with a computer program stored therein that contains the instructions for performing the method.

In some embodiments, the control unit 38 is configured for closed-loop control, control and monitoring of the forces at the relative movement device 36 when performing the bending of the different arrester tabs 12.1a-12.4a, 12.1b-12.4b in order to prevent damage to the arrester tabs 12.1a-12.4a, 12.1b-12.4b during bending and/or to detect incorrectly bent arrester tabs.

In some embodiments, the control unit 38 is designed to control the relative movement device 36 in such a way that re-forming of the arrester tab due to an elastic material behavior is compensated. For example, a movement takes place slightly beyond the actual dimensions D1, D2, w2 in order to compensate for re-forming.

The bending apparatus 30 is designed for bending arrester tabs 12.1a-12.4a, 12.1b-12.4b with different thicknesses and/or materials without changing tools. For this purpose, only a corresponding programming or setting of the control unit 38 is required.

Due to the telescopic extension 56, the entire bending apparatus 30 can be moved to adjust to the respective position of the pouch cell 14.1-14.4 to be processed and/or to move the bending apparatus 30 into a rest and/or maintenance position.

To enable optimal bending of arrester tabs of battery cells, such as pouch cells (14.1-14.4), which are to be assembled at different positions to form a battery module or a battery pack, in a flexible manner by simple means, the invention provides a bending method for bending the arrester tabs (12.1a-12.4a; 12.1b-12.4b), comprising:
a) providing a first battery cell (e.g., first pouch cell 14.1) having a first arrester tab (12.1a; 12.1b) and a second battery cell (e.g., second pouch cell 14.2) having a second arrester tab (12.2a; 12.2b) and
b) bending over of the first arrester tab (12.1a; 12.1b) and the second arrester tab (12.2a; 23.2b) differently;
   wherein step b) comprises the steps of:
b1) providing a first and a second holding device (32, 34) for holding first and second end portions (22.3, 22.2) respectively of the arrester tab (12.1a, 12.2a; 12.1b, 12.2b) to be bent, the holding devices being relatively movable by means of a computer-controlled relative moving device (36),
b2) holding the first arrester tab (12.1a; 12.1b) with the holding devices (32, 34) and controlling the relative movement device (36) to bend the first arrester tab (12.1a; 12.1b) into a first bent shape; and
b3) holding the second arrester tab (12.2a; 12.2b) with the holding devices (32, 34) and controlling the relative movement device (36) differently from step b2) to bend the second arrester tab (12.2a; 12.2b) into a second bent shape different from the first bent shape.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

12.1a first arrester tab (positive pole)
12.1b first arrester tab (negative pole)
12.2a second arrester tab (positive pole)
12.2b second arrester tab (negative pole)
12.3a third arrester tab (positive pole)
12.3b third arrester tab (negative pole)
12.4a fourth arrester tab (positive pole)
12.4b fourth arrester tab (negative pole)
14.1 first pouch cell (example of first battery cell)
14.2 second pouch cell (example for second battery cell)
14.3 third pouch cell (example for third battery cell)
14.4 fourth pouch cell (example for fourth battery cell)
16 electrode arrangement
18 foil envelope
20 first leg
22 second leg
24 base (arrester tab)
30 bending apparatus
32 first holding device
34 second holding device
36 relative movement device
38 control unit
40 longitudinal movement unit
40.1 first linear axis (linear axis of the longitudinal movement unit, X-axis)
40.2 first linear movement mechanism (longitudinal movement unit)
40.3 first servo drive (longitudinal movement unit)
42 transverse movement unit
42.1 second linear axis (linear axis of the transverse movement unit, Y-axis)
42.2 second linear movement mechanism (transverse movement unit)
42.3 second servo drive (transverse movement unit)
44 rotary movement unit
44.1 third linear axis (linear axis of the rotary movement unit)
44.2 third linear movement mechanism (longitudinal movement unit)
44.3 third servo drive (longitudinal movement unit)
46 base (bending apparatus)
50.1 first clamping unit
50.2 second clamping unit
54 bending unit
56 telescopic extension
58 hold-down device
60 presser
62 parallel gripper
64 coupling rod
66 rotary axis
68 gripper jaws
D1 distance between the bending edges in the longitudinal direction of the deflector tab (X-direction)
D2 distance between the bending edges in the transverse direction (Y direction)
L1 length of the first leg
L2 length of the second leg
w1 angle between base and first leg
w2 angle between legs

1. A method carried out during manufacturing a battery module or a battery pack from battery cells by bending arrester tabs of battery cells, the method comprising:
a) providing a first battery cell having a first arrester tab and a second battery cell having a second arrester tab, and
b) bending over the first arrester tab and the second arrester tab in such a way that the first and second arrester tabs are bent differently;
wherein step b) comprises the steps of:
b1) providing a bending apparatus comprising a first holding device for holding a first end portion of an arrester tab to be bent, a second holding device for holding a second end portion of the arrester tab to be bent, and a computer-controlled relative movement device for relatively moving the first and second holding devices in at least two directions of movement,
b2) holding the first arrester tab with the first and second holding devices and controlling the relative movement device to bend the first arrester tab into a first bent shape;
b3) holding the second arrester tab with the first and second holding devices and controlling the relative movement device differently from step b2) to bend the second arrester tab into a second bent shape different from the first bent shape.

2. The method according to claim 1, wherein step b1) comprises providing the relative movement device with at least one or more of the following:
a longitudinal movement unit for relatively moving the first and the second holding devices with at least one directional component in a longitudinal direction to the arrester tab to be bent;
a transverse movement unit for the relative movement of the first and second holding devices with at least one directional component transverse to the arrester tab to be bent; and,
a rotary movement unit for relatively rotating the first and second holding devices.

3. The method according to claim 1, wherein step b1) comprises providing the first holding device with a first clamping unit, which has a first hold-down device, with a second clamping unit, which has a second hold-down device, and with at least one presser arranged on at least one of the first and second clamping units so as to be movable relative thereto,
and in that the first end portion is held by relatively moving the first and second hold-down devices towards each other and the arrester tab is brought into a defined position by the at least one presser.

4. The method according to claim 1, wherein step b1) comprises providing the second holding device with a parallel gripper which is movable by the relative movement device for bending the arrester tab.

5. The method according to claim 1, wherein step b) comprises at least one or more of the following steps:
b.i) closed-loop controlling, controlling, monitoring, or a combination thereof forces at the relative movement device when performing step b2), b3), or both in order to avoid damage to the arrester tab during bending, to detect incorrectly bent arrester tabs, or both;
b.ii) controlling the relative movement device in such a way that a reverse deformation of the arrester tab due to an elastic material behavior is compensated;
b.iii) bending arrester tabs with different thicknesses, materials, or both with the bending apparatus without changing tools;
b.iv) moving the entire bending apparatus for adjusting to a respective position of a battery cell to be processed, for moving the bending apparatus into a rest position, for moving the bending apparatus into a maintenance position, or a combination thereof;
b.v) moving the first battery cell laterally into the bending apparatus, clamping the first end portion of the first arrester tab with the first holding device, positioning the first arrester tab with a positioning element, clamping the second end portion of the first arrester tab with the second holding device, bending the first arrester tab by moving the second holding device in accordance with a first movement pattern, opening the first and second holding devices and clocked further movement of the first battery cell; and,
b.vi) moving the second battery cell laterally into the bending apparatus, clamping a first end region of the second arrester tab with the first holding device, positioning the second arrester tab with a positioning element, clamping a second end region of the second arrester tab with the second holding device, bending the second arrester tab by moving the second holding device in accordance with a second movement pattern, opening the first and second holding devices and clocked further movement of the second battery cell.

6. A method for manufacturing a battery module or battery pack from battery cells, the method comprising:
carrying out the method according to claim 1, and
c) electrically contacting the first and second arrester tabs to form a battery module or battery pack.

7. An apparatus for bending arrester tabs of battery cells while manufacturing a battery module or battery pack from battery cells, the apparatus comprising:
a first holding device for holding a first end portion of an arrester tab to be bent, a second holding device for holding a second end portion of the arrester tab and a computer-controlled relative movement device for relatively moving the first and second holding devices in at least two directions of movement, and a controller which is designed to control the relative movement device in accordance with a first movement pattern for bending a first arrester tab into a first bent shape and in accordance with a second movement pattern for bending a second arrester tab into a second bent shape.

8. The apparatus according to claim 7, wherein the controller is configured to control the bending apparatus to bend over the first arrester tab and the second arrester tab in such a way that the first and second arrester tabs are bent differently.

9. The apparatus according to claim 7, wherein the relative movement device comprises at least one or more of the following:
9.1 a longitudinal movement unit for relatively moving the first and the second holding devices with at least one directional component in a longitudinal direction to the arrester tab to be bent;
9.2 a transverse movement unit for relatively moving the first and the second holding devices with at least one directional component transverse to the arrester tab to be bent; and,
9.3 a rotary movement unit for relatively rotating the first and second holding devices.

10. The apparatus according to claim 9, wherein respective units of the relative movement device each have a linear axis which has a linear movement mechanism and a servo drive.

11. The apparatus according to claim 7, wherein the holding devices and the relative movement device are arranged on a linearly movable base which is movable between a waiting or maintenance position and a bending position for carrying out the bending.

12. The apparatus according to claim 7, wherein the first holding device has a first clamping unit with a first hold-down device, a second clamping unit with a second hold-down device and at least one presser arranged on at least one of the first and second clamping units so as to be movable relative thereto, or
wherein a bending unit is provided which comprises a gripper, which can be moved with the relative movement device, as a second holding device, or
both.

13. A control unit for a bending apparatus, wherein the control unit is configured to control the bending apparatus for performing the method according to claim 1.

14. A non-transitory computer readable medium storing a computer program comprising instructions that cause a bending apparatus to perform the method according to claim 1.
